(19) United States
(12) Patent Application Publication
(10) Pub. No.: US 2015/0132567 A1
(43) Pub. Date: May 14, 2015

(54) PRESSURE-SENSITIVE ADHESIVE LAYER FOR OPTICAL FILM, PRESSURE-SENSITIVE ADHESIVE LAYER-BEARING OPTICAL FILM, AND IMAGE DISPLAY DEVICE

(71) Applicant: NITTO DENKO CORPORATION, Ibaraki-shi, Osaka (JP)

(72) Inventors: Taiki Shimokuri, Ibaraki-shi (JP); Kunihiro Inui, Ibaraki-shi (JP); Toshitaka Takahashi, Ibaraki-shi (JP); Yousuke Makihata, Ibaraki-shi (JP); Toshitsugu Hosokawa, Ibaraki-shi (JP); Takaaki Ishii, Ibaraki-shi (JP)

(73) Assignee: NITTO DENKO CORPORATION, Ibaraki-shi, Osaka (JP)

(21) Appl. No.: 14/400,682

(22) PCT Filed: Apr. 16, 2013
(86) PCT No.: PCT/JP2013/061290

§ 371 Date: Nov. 12, 2014

(30) Foreign Application Priority Data
May 24, 2012 (JP) 2012-118748
Apr. 8, 2013 (JP) 2013-080706

(51) Int. Cl. C09J 133/08

(52) U.S. Cl. CPC C09J 133/08; C09J 2201/606
USPC 428/327; 524/521

(57) ABSTRACT

It is an object of the invention to provide a pressure-sensitive adhesive layer that is designed for an optical film to be less likely to cause depolarization and to have good reworkability and good recyclability. The present invention relates to a pressure-sensitive adhesive layer for an optical film made from an aqueous dispersion-type pressure-sensitive adhesive composition, wherein
the aqueous dispersion-type pressure-sensitive adhesive composition contains an emulsion particle having a core-shell structure comprising a shell layer of (A) a (meth)acryl-based copolymer and a core layer of (B) a methacryl-based copolymer in a single emulsion particle,
a mixture ratio (A)/(B) (on a solid weight basis) of the (meth)acryl-based copolymer (A) and the methacryl-based copolymer (B) is in the range of 50/50 to 90/10,
the emulsion particle in the aqueous dispersion-type pressure-sensitive adhesive composition has a number average particle size of 10 nm to 100 nm.

### TECHNICAL FIELD

The invention relates to a pressure-sensitive adhesive layer for an optical film and to a pressure-sensitive adhesive layer-bearing optical film including an optical film and the pressure-sensitive adhesive layer provided on at least one side of the optical film. The invention also relates to an image display device, such as a liquid crystal display device, an organic electroluminescent (EL) display device, a cathode ray tube (CRT), a plasma display panel (PDP), produced with the pressure-sensitive adhesive layer-bearing optical film.

### DESCRIPTION OF THE RELATED ART

Liquid crystal display devices, organic EL display devices, etc. have an image-forming mechanism including polarizing elements as essential components. For example, therefore, in a liquid crystal display device, polarizing elements are essentially placed on both sides of a liquid crystal cell, and generally, polarizing plates are attached as the polarizing elements. Besides polarizing plates, various optical elements have been used in display panels such as liquid crystal panels and organic EL panels for improving display quality. Front face plates are also used to protect image display devices such as liquid crystal display devices, organic EL display devices, CRTs, and PDPs or to provide a high-grade appearance or a differentiated design. Examples of parts used in image display devices such as liquid crystal display devices and organic EL display devices or parts used together with image display devices, such as front face plates, include retardation plates for preventing discoloration, viewing angle-widening films for improving the viewing angle of liquid crystal displays, brightness enhancement films for increasing the contrast of displays, and surface treatment films such as hard-coat films for use in imparting scratch resistance to surfaces, antiglare treatment films for preventing glare on image display devices, and anti-reflection films such as anti-reflective films and low-reflective films. These films are generically called optical films.

When such optical films are bonded to a display panel such as a liquid crystal cell or an organic EL panel or bonded to a front face plate, a pressure-sensitive adhesive is generally used. In the process of bonding an optical film to a display panel such as a liquid crystal cell or an organic EL panel or to a front face plate or bonding optical films together generally reduce optical loss. Therefore, a pressure-sensitive adhesive is used to bond the materials together. In such a case, a pressure-sensitive adhesive layer-bearing optical film including an optical film and a pressure-sensitive adhesive layer previously formed on one side of the optical film is generally used, because it has some advantages such as no need for a drying process to fix the optical film.

In the process of bonding a pressure-sensitive adhesive layer-bearing optical film to a display panel such as a liquid crystal cell or an organic EL panel or to a front face plate, they can be misaligned, or a contaminant can be caught between the bonded surfaces. In such a case, the optical film may be peeled off from the liquid crystal cell or the like and be reused. When peeled off, the pressure-sensitive adhesive layer-bearing optical film is required not to have an adhesive state that can change the gap of the liquid crystal cell, reduce the function of the organic EL panel, or break the optical film. In other words, the pressure-sensitive adhesive layer-bearing optical film is required to have removability (reworkability) so that it can be easily peeled off.

The pressure-sensitive adhesive layer-bearing optical film is also required to have recyclability so that it can be easily peeled off from the display panel such as the liquid crystal cell or the organic EL panel or from the front face plate for the purpose of recycling the display panel or the front face plate component after an image display device having the display panel with the pressure-sensitive adhesive layer-bearing optical film bonded thereto or a product having the front face plate with the pressure-sensitive adhesive layer-bearing optical film bonded thereto is used in home or office for a long period of time. However, if the pressure-sensitive adhesive layer-bearing optical film has too high an adhesive strength, a problem can occur, such as breakage of the film or an adhesive residue on the display panel such as the liquid crystal cell or the organic EL panel or on the front face plate. In addition, the reworking or recycling process is required to be performed at a higher peel rate. Unfortunately, the adhesive strength of conventional pressure-sensitive adhesive layers increases with increasing peel rate, which causes a problem in that a sufficient level of reworkability or recyclability cannot be achieved.

Organic solvent-type pressure-sensitive adhesives have been dominantly used to form the pressure-sensitive adhesive layer of the pressure-sensitive adhesive layer-bearing optical film (see, for example, Patent Document 1). In recent years, it has been required to reduce the use of organic solvents in order to reduce global environmental loading or improve process stability, and, for example, organic solvent-type pressure-sensitive adhesives are required to be replaced with aqueous dispersion-type pressure-sensitive adhesives containing a pressure-sensitive adhesive polymer component dispersed in water. However, such aqueous dispersion-type pressure-sensitive adhesives have the following problem. When such pressure-sensitive adhesives are used to form pressure-sensitive adhesive layers, the adhesive polymer particles are concentrated and dried. Therefore, the resulting pressure-sensitive adhesive layers have a lot of particle interfaces, from which light can be scattered to cause depolarization, so that optical films can have reduced contrast when having the pressure-sensitive adhesive layers. The pressure-sensitive adhesive layer-induced depolarization has become a new problem particularly because optical films have been required to have higher contrast in recent years.

As an aqueous dispersion-type pressure-sensitive adhesive, for example, there is a known aqueous dispersion-type pressure-sensitive adhesive composition for an optical film, which includes two (meth)acryl-based copolymers each having a specific glass transition temperature (see, for example, Patent Document 2). However, Patent Document 2 does not show any study on the average particle size of emulsion particles in the pressure-sensitive adhesive composition. When used to form a high-contrast panel or the like, the pressure-sensitive adhesive composition disclosed in Patent Document 2 tends to cause depolarization and a reduction in contrast and therefore has a room to be improved with respect to the depolarization.

There is also a known pressure-sensitive adhesive layer improved with respect to depolarization (see, for example, Patent Document 3). The known pressure-sensitive adhesive layer is for an optical film and made from an aqueous dispersion-type pressure-sensitive adhesive composition containing emulsion particles. In the layer, the number average particle size of the polymer particles and the distance between the particles are controlled. However, when an optical film having the pressure-sensitive adhesive layer disclosed in Patent Document 3 is peeled off from a liquid crystal panel or the like, the optical film can be broken or an adhesive residue can remain on the liquid crystal panel or the like. The pressure-sensitive adhesive layer disclosed in Patent Document 3 has a room to be improved with respect to reworkability.

There is also a known aqueous dispersion-type pressure-sensitive adhesive composition for products other than optical films, which has improved adhesive strength and other properties to a non-polar backing material such as polyolefin (see, for example, Patent Document 4). However, the aqueous dispersion-type pressure-sensitive adhesive composition disclosed in Patent Document 4 contains a tackifier, and, therefore, pressure-sensitive adhesive layers made from the composition have high haze and are not suitable for use on optical films.

As mentioned above, conventional pressure-sensitive adhesive layers for optical films are not satisfactory with respect to all of depolarization, reworkability, and recyclability. Some conventional pressure-sensitive adhesive layers have poor reworkability and recyclability although they can satisfy the requirements for depolarization. On the other hand, some conventional pressure-sensitive adhesive layers are unfavorable for depolarization although they have a satisfactory level of reworkability and recyclability. At present, therefore, there has been no known pressure-sensitive adhesive layer for an optical film to meet the requirements for all of depolarization, reworkability, and recyclability.

### PRIOR ART DOCUMENTS

### Patent Documents

Patent Document 1: JP-A-2010-007044

Patent Document 2: WO 2011/145552 pamphlet

Patent Document 3: JP-A-2010-211128

Patent Document 4: JP-A-2006-016517

### SUMMARY OF THE INVENTION

### Problems to be Solved by the Invention

It is an object of the invention to provide a pressure-sensitive adhesive layer for an optical film to be less likely to cause depolarization and to have good reworkability and good recyclability. It is another object of the invention to provide a pressure-sensitive adhesive layer-bearing optical film including an optical film and such a pressure-sensitive adhesive layer placed on at least one side of the optical film, and an image display device having such a pressure-sensitive adhesive layer-bearing optical film.

### Means for Solving the Problems

As a result of earnest studies to solve the above problems, the inventors have accomplished the present invention based on the finding that the pressure-sensitive adhesive layer for an optical film described below can solve the problems.

The present invention relates to a pressure-sensitive adhesive layer for an optical film made from an aqueous dispersion-type pressure-sensitive adhesive composition, wherein

the aqueous dispersion-type pressure-sensitive adhesive composition contains emulsion particle having a core-shell structure comprising a shell layer of (A) a (meth)acryl-based copolymer and a core layer of (B) a methacryl-based copolymer in a single emulsion particle,

the (meth)acryl-based copolymer (A) contains an alkyl (meth)acrylate and a carboxyl group-containing monomer as a monomer unit and has a glass transition temperature of −55° C. to less than 0° C., which is calculated based on monofunctional monomers for monomer units,

the methacryl-based copolymer (B) contains an alkyl methacrylate and a carboxyl group-containing monomer as a monomer unit, wherein a content of the monomer unit of the alkyl methacrylate is 68 to 82% by weight of all monomer units of the methacryl-based copolymer (B),

the methacryl-based copolymer (B) has a glass transition temperature of 0° C. to 180° C.,

a difference of the glass transition temperatures between the (meth)acryl-based copolymer (A) and the methacryl-based copolymer (B) is 50° C. or more,

a mixture ratio (A)/(B) (on a solid weight basis) of the (meth)acryl-based copolymer (A) and the methacryl-based copolymer (B) is in the range of 50/50 to 90/10,

the emulsion particle in the aqueous dispersion-type pressure-sensitive adhesive composition has a number average particle size of 10 nm to 100 nm.

The pressure-sensitive adhesive layer of the invention preferably has an adhesive strength of 1 to 15 N/25 mm to glass at a peel rate of 300 mm/minute after bonded to the glass and stored at 23° C. for 30 days or less, and which has an adhesive strength, to glass at a peel rate of more than 300 mm/minute, of equal to less than the adhesive strength to glass at a peel rate of 300 mm/minute.

The pressure-sensitive adhesive layer of the invention preferably has an adhesive strength of 1 to 25 N/25 mm to glass at a peel rate of 300 mm/minute after bonded to the glass and stored at 60° C. for 1,000 hours, and which has an adhesive strength, to glass at a peel rate of more than 300 mm/minute, of equal to less than the adhesive strength to glass at a peel rate of 300 mm/minute.

The pressure-sensitive adhesive layer of the invention preferably provides a depolarization value of 0.015 or less, wherein the depolarization value is a difference between the degree of polarization of a pressure-sensitive adhesive layer-bearing optical film comprising an optical film and the pressure-sensitive adhesive layer placed thereon and the degree of polarization of the optical film itself.

In the pressure-sensitive adhesive layer of the invention, the (meth)acryl-based copolymer (A) and the methacryl-based copolymer (B) are preferably each obtained by emulsion polymerization of a monomer mixture containing a vinyl monomer capable of forming a homopolymer with a glass transition temperature of 50° C. or higher.

The invention also relates to a pressure-sensitive adhesive layer-bearing optical film, comprising an optical film and the pressure-sensitive adhesive layer of the invention placed on at least one side of the optical film. The invention also relates to an image display device, comprising at least one piece of the pressure-sensitive adhesive layer-bearing optical film of the invention.

### Effect of the Invention

The invention makes it possible to provide a pressure-sensitive adhesive layer for an optical film to be less likely to cause depolarization and to have good reworkability and good recyclability. The invention also makes it possible to provide a pressure-sensitive adhesive layer-bearing optical film including an optical film and such a pressure-sensitive adhesive layer placed on at least one side of the optical film, and an image display device having such a pressure-sensitive adhesive layer-bearing optical film.

### MODE FOR CARRYING OUT THE INVENTION

The pressure-sensitive adhesive layer of the invention for an optical film is made from an aqueous dispersion-type pressure-sensitive adhesive composition that contains emulsion particles each having a core-shell structure including a shell layer of (A) a (meth)acryl-based copolymer and a core layer of (B) a methacryl-based copolymer. The (meth)acryl-based copolymer (A) contains a monomer unit derived from an alkyl (meth)acrylate and a monomer unit derived from a carboxyl group-containing monomer and has a glass transition temperature of −55° C. to less than 0° C., which is calculated based on data on the monofunctional monomers among the monomers used to form the copolymer (A). The methacryl-based copolymer (B) contains a monomer unit derived from an alkyl methacrylate and a monomer unit derived from a carboxyl group-containing monomer, in which the monomer unit derived from the alkyl methacrylate makes up 68 to 82% by weight of all the monomer units of the methacryl-based copolymer (B). The methacryl-based copolymer (B) has a glass transition temperature of 0° C. to 180° C., which is calculated based on data on the monofunctional monomers among the monomers used to form the copolymer (B).

The (meth)acryl-based copolymer (A) has a glass transition temperature of −55° C. to less than 0° C. Within this range, the pressure-sensitive adhesive can have reliable adhesion and be prevented from having lower cohesive strength. The glass transition temperature is preferably −20° C. or lower, more preferably −30° C. or lower, even more preferably −35° C. or lower, further more preferably −40° C. or lower. If the (meth)acryl-based copolymer (A) has a glass transition temperature of 0° C. or higher, the pressure-sensitive adhesive will tend to have lower adhesion. On the other hand, the glass transition temperature is preferably −50° C. or higher, more preferably −45° C. or higher, even more preferably higher than −45° C. If the (meth)acryl-based copolymer (A) has a glass transition temperature of lower than −55° C., the pressure-sensitive adhesive will tend to have lower cohesive strength and to easily come off.

The methacryl-based copolymer (B) has a glass transition temperature of 0° C. to 180° C. Within this range, the reworkability and the recyclability can be improved. The glass transition temperature is preferably 40° C. or higher, more preferably 50° C. or higher, even more preferably 60° C. or higher. If the methacryl-based copolymer (B) has a glass transition temperature of lower than 0° C., the pressure-sensitive adhesive will tend to have lower cohesive strength and to easily come off and will be inferior in reworkability or recyclability. On the other hand, the glass transition temperature is preferably 110° C. or lower, more preferably 90° C. or lower, even more preferably lower than 90° C.

There is a difference of 50° C. or more between the glass transition temperatures of the (meth)acryl-based copolymer (A) and the methacryl-based copolymer (B). The glass transition temperature difference is preferably 70° C. or more, more preferably 80° C. or more, even more preferably 90° C. or more, further more preferably 100° C. or more. When the glass transition temperature difference falls within these ranges, the pressure-sensitive adhesive can have reliable adhesion, be prevented from having lower cohesive strength, and be good in reworkability and recyclability.

The glass transition temperatures of the (meth)acryl-based copolymer (A) and the methacryl-based copolymer (B) are theoretical values each calculated from the following FOX equation taking into account the types and contents of the monomer units of each polymer.

1/Tg=w₁/Tg₁+w₂/Tg₂+ . . . +wₙ/Tgₙ FOX equation

(Tg: the glass transition temperature (K) of the polymer; Tg₁, Tg₂, . . . Tgₙ: the glass transition temperatures (K) of the homopolymers of the respective monomers; w₁, w₂, . . . wₙ: the weight fractions of the respective monomers)

It should be noted that the glass transition temperatures of the (meth)acryl-based copolymers (A) and the methacryl-based copolymer (B) are calculated based on the monofunctional monomers. Namely, even when the polymers each contain a polyfunctional monomer as a monomer unit, the polyfunctional monomer is neglected in the calculation of the glass transition temperature, because the polyfunctional monomer is used in a small amount so that its influence on the glass transition temperature of the copolymer is low. It should also be noted that an alkoxysilyl group-containing monomer is recognized as a polyfunctional monomer and therefore neglected in the calculation of the glass transition temperatures. The theoretical glass transition temperatures calculated from the FOX equation well agree with actual glass transition temperatures determined from differential scanning calorimetry (DSC), dynamic viscoelasticity, etc.

In the (meth)acryl-based copolymer (A), the monomer unit type and the component composition are not restricted as long as they contain an alkyl (meth)acrylate and a carboxyl group-containing monomer as monomer units and satisfy the requirements for the glass transition temperatures. The term “alkyl (meth)acrylate” refers to alkyl acrylate and/or alkyl methacrylate, and “(meth)” is used in the same meaning in the description.

In view of emulsion polymerization reactivity, the alkyl (meth)acrylate used to form the (meth)acryl-based copolymer (A) preferably has a water solubility in a specific range, and an alkyl acrylate having an alkyl group of 1 to 18 carbon atoms is preferably used to form a major component, so that the glass transition temperature can be easily controlled. Examples of the alkyl acrylate include methyl acrylate, ethyl acrylate, propyl acrylate, n-butyl acrylate, tert-butyl acrylate, n-hexyl acrylate, cyclohexyl acrylate, 2-ethylhexyl acrylate, n-octyl acrylate, lauryl acrylate, tridecyl acrylate, stearyl acrylate, and other alkyl esters of acrylic acid. These may be used alone or in combination of two or more. Among these, an alkyl acrylate having an alkyl group of 3 to 9 carbon atoms is preferable, such as propyl acrylate, n-butyl acrylate, 2-ethylhexylacrylate, or n-octyl acrylate. The content of the alkyl acrylate(s) in all monomer units of (meth)acryl-based copolymer (A) is preferably from 60 to 99.9% by weight, more preferably from 70 to 99.9% by weight, even more preferably from 80 to 99.9% by weight, still more preferably from 80 to 99% by weight, and yet more preferably from 80 to 95% by weight.

In view of emulsion polymerization reactivity, the (meth)acryl-based copolymer (A) preferably has a water solubility in a specific range, and an alkyl methacrylate having an alkyl group of 1 to 18 carbon atoms may be used, so that the glass transition temperature can be easily controlled. Examples of the alkyl methacrylate include methyl methacrylate, ethyl methacrylate, propyl methacrylate, n-butyl methacrylate, tert-butyl methacrylate, n-hexyl methacrylate, cyclohexyl methacrylate, 2-ethylhexyl methacrylate, n-octyl methacrylate, lauryl methacrylate, tridecyl methacrylate, stearyl methacrylate, isobornyl methacrylate, and other alkyl esters of methacrylic acid. These may be used alone or in combination of two or more. Among these, methyl methacrylate, ethyl methacrylate, and cyclohexyl methacrylate are preferred. The content of the alkyl methacrylate(s) in all monomer units of (meth)acryl-based copolymer (A) is preferably 39.9% by weight or less, more preferably 30% by weight or less, even more preferably 20% by weight or less, still more preferably 15% by weight or less, and yet more preferably 10% by weight or less.

To improve the tackiness of the pressure-sensitive adhesive and provide stability for the emulsion, a carboxyl group-containing monomer is used to form the (meth)acryl-based copolymer (A). The carboxyl group-containing monomer may be monomer having a carboxyl group and a radically-polymerizable unsaturated double bond-containing group such as a (meth)acryloyl group or a vinyl group, examples of which include (meth)acrylic acid, itaconic acid, maleic acid, fumaric acid, crotonic acid, carboxyethyl acrylate, and carboxypentyl acrylate. The content of the carboxyl group-containing monomer in all monomer units of the (meth)acryl-based polymer (A) is preferably from 0.1 to 10% by weight, more preferably from 0.5 to 7% by weight, and even more preferably from 1 to 5% by weight.

In addition to the alkyl (meth)acrylate and the carboxyl group-containing monomer, at least one copolymerizable monomer having an unsaturated double bond-containing polymerizable group such as a (meth)acryloyl group or a vinyl group may be introduced into the (meth)acryl-based polymer (A) by copolymerization in order to stabilize water dispersibility, to improve adhesion to a base material such as an optical film for the pressure-sensitive adhesive layer, and to improve initial tackiness to the adherend.

An alkoxysilyl group-containing monomer is mentioned as the copolymerizable monomer. The alkoxysilyl group-containing monomer may be a silane coupling agent-type unsaturated monomer having an alkoxysilyl group and a group having at least one unsaturated double bond, such as a (meth)acryloyl group or a vinyl group. The alkoxysilyl group-containing monomer is preferred in order to allow the (meth)acryl-based copolymer (A) to have a cross linked structure and improved adhesion to glass.

Examples of the alkoxysilyl group-containing monomer include an alkoxysilyl group-containing (meth)acrylate monomer and an alkoxysilyl group-containing vinyl monomer.

Examples of the alkoxysilyl group-containing (meth)acrylate monomer include (meth)acryloyloxyalkyl-trialkoxysilanes such as
(meth)acryloyloxymethyl-trimethoxysilane,
(meth)acryloyloxymethyl-triethoxysilane,
2-(meth)acryloyloxyethyl-trimethoxysilane,
2-(meth)acryloyloxyethyl-triethoxysilane,
3-(meth)acryloyloxypropyl-trimethoxysilane,
3-(meth)acryloyloxypropyl-triethoxysilane,
3-(meth)acryloyloxypropyl-tripropoxysilane,
3-(meth)acryloyloxypropyl-triisopropoxysilane, and
3-(meth)acryloyloxypropyl-tributoxysilane;
(meth)acryloyloxyalkyl-alkyldialkoxysilanes such as
(meth)acryloyloxymethyl-methyldimethoxysilane,
(meth)acryloyloxymethyl-methyldiethoxysilane,
2-(meth)acryloyloxyethyl-methyldimethoxysilane,
2-(meth)acryloyloxyethyl-methyldiethoxysilane,
3-(meth)acryloyloxypropyl-methyldimethoxysilane,
3-(meth)acryloyloxypropyl-methyldiethoxysilane,
3-(meth)acryloyloxypropyl-methyldipropoxysilane,
3-(meth)acryloyloxypropyl-methyldiisopropoxysilane,
3-(meth)acryloyloxypropyl-methyldibutoxysilane,
3-(meth)acryloyloxypropyl-ethyldimethoxysilane,
3-(meth)acryloyloxypropyl-ethyldiethoxysilane,
3-(meth)acryloyloxypropyl-ethyldipropoxysilane,
3-(meth)acryloyloxypropyl-ethyldiisopropoxysilane,
3-(meth)acryloyloxypropyl-ethyldibutoxysilane,
3-(meth)acryloyloxypropyl-propyldimethoxysilane, and
3-(meth)acryloyloxypropyl-propyldiethoxysilane; and
(meth)acryloyloxyalkyl-dialkyl(mono)alkoxysilanes
   corresponding to these monomers.

For example, alkoxysilyl group-containing vinyl monomers include vinyltrialkoxysilanes such as vinyltrimethoxysilane, vinyltriethoxysilane, vinyltripropoxysilane, vinyltriisopropoxysilane, and vinyltributoxysilane, and vinylalkyldialkoxysilanes and vinyldialkylalkoxysilanes corresponding thereto; vinylalkyltrialkoxysilanes such as vinylmethyltrimethoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, and γ-vinylpropyltributoxysilane, and (vinylalkyl)alkyldialkoxysilanes and (vinylalkyl)dialkyl(mono)alkoxysilanes corresponding thereto.

The content of the alkoxysilyl group-containing monomer in all monomer units of the (meth)acryl-based polymer (A) is preferably from 0.001 to 1% by weight, more preferably from 0.01 to 0.5% by weight, and even more preferably from 0.03 to 0.1% by weight. If it is less than 0.001% by weight, the effect of using the alkoxysilyl group-containing monomer (providing a crosslinked structure and adhesion to glass) may be insufficiently obtained. If it is more than 1% by weight, the pressure-sensitive adhesive layer may have a too high degree of crosslinkage, so that the pressure-sensitive adhesive layer may crack over time.

The copolymerizable monomer may be a phosphate group-containing monomer. The phosphate group-containing monomer is effective in improving adhesion to glass.

For example, the phosphate group-containing monomer may be a phosphate group-containing monomer represented by formula (1) below.

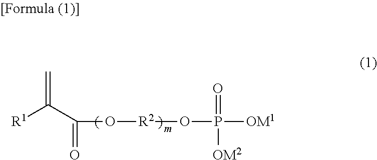

In formula (1), R¹ represents a hydrogen atom or a methyl group, R² represents an alkylene group of 1 to 4 carbon atoms, m represents an integer of 2 or more, and M¹ and M² each independently represent a hydrogen atom or a cation.

In formula (1), m is 2 or more, preferably 4 or more, generally 40 or less, and m represents the degree of polymerization of the oxyalkylene groups. The polyoxyalkylene group may be a polyoxyethylene group or a polyoxypropylene group, and these polyoxyalkylene groups may include random, block, or graft units. The cation of the salt of the phosphate group is typically, but not limited to, an inorganic cation such as an alkali metal such as sodium or potassium or an alkaline-earth metal such as calcium or magnesium, or an organic cation such as a quaternary amine.

The content of the phosphate group-containing monomer in all monomer units of the (meth)acryl-based polymer (A) is preferably 20% by weight or less, more preferably from 0.1 to 20% by weight. If it is more than 20% by weight, it is not preferable in view of polymerization stability.

Examples of copolymerizable monomers other than the alkoxysilyl group-containing monomer and the phosphate group-containing monomer include acid anhydride group-containing monomers such as maleic anhydride and itaconic anhydride; aryl (meth)acrylate such as phenyl (meth)acrylate; vinyl esters such as vinyl acetate and vinyl propionate; styrene monomers such as styrene; epoxy group-containing monomers such as glycidyl (meth)acrylate and methylglycidyl (meth)acrylate; hydroxyl group-containing monomers such as 2-hydroxyethyl acrylate and 2-hydroxypropyl acrylate; nitrogen atom-containing monomers such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylolpropane(meth)acrylamide, (meth)acryloylmorpholine, aminoethyl (meth)acrylate, N,N-dimethylaminoethyl (meth)acrylate, and tert-butylaminoethyl (meth)acrylate; alkoxy group-containing monomers such as methoxyethyl (meth)acrylate and ethoxyethyl (meth)acrylate; cyano group-containing monomers such as acrylonitrile and methacrylonitrile; functional monomers such as 2-methacryloyloxyethyl isocyanate; olefin monomers such as ethylene, propylene, isoprene, butadiene, and isobutylene; vinyl ether monomers such as vinyl ether; halogen atom-containing monomers such as vinyl chloride; and other monomers including vinyl group-containing heterocyclic compounds such as N-vinylpyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, and N-vinylmorpholine, and N-vinylcarboxylic acid amides.

Examples of the copolymerizable monomer also include maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; and sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid.

Examples of the copolymerizable monomer also include glycol acrylate monomers such as polyethylene glycol (meth)acrylate, polypropylene glycol (meth)acrylate, methoxyethylene glycol (meth)acrylate, and methoxypolypropylene glycol (meth)acrylate; and other monomers such as acrylic ester monomers containing a heterocyclic ring or a halogen atom, such as tetrahydrofurfuryl (meth)acrylate and fluoro(meth)acrylate.

A polyfunctional monomer, other than the above alkoxysilyl group-containing monomer, may also be used as the copolymerizable monomer for a purpose such as control of the gel fraction of the aqueous dispersion-type pressure-sensitive adhesive composition. The polyfunctional monomer may be a compound having two or more unsaturated double bonds such as those in (meth)acryloyl groups or vinyl groups. Examples that may also be used include (meth)acrylate esters of polyhydric alcohols, such as (mono or poly)alkylene glycol di(meth)acrylates including (mono or poly)ethylene glycol di(meth)acrylates such as ethylene glycol di(meth)acrylate, diethylene glycol di(meth)acrylate, triethylene glycol di(meth)acrylate, trimethylolpropane tri(meth)acrylate, and tetraethylene glycol di(meth)acrylate, (mono or poly)propylene glycol di(meth)acrylate such as propylene glycol di(meth)acrylate, neopentyl glycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; polyfunctional vinyl compounds such as divinylbenzene; diacetone acrylamide; and compounds having two or more reactive unsaturated double bonds which have different reactivity respectively, such as allyl (meth)acrylate and vinyl (meth)acrylate. The polyfunctional monomer may also be a compound having a polyester, epoxy or urethane skeleton to which two or more unsaturated double bonds are added in the form of functional groups such as (meth)acryloyl groups or vinyl groups in the same manner as the monomer component, such as polyester (meth)acrylate, epoxy (meth)acrylate, or urethane (meth)acrylate.

When a monofunctional monomer is used as the copolymerizable monomer other than the alkoxysilyl group-containing monomer and the phosphate group-containing monomer, the content of the copolymerizable monomer in all monomer units of the (meth)acryl-based polymer (A) is preferably 20% by weight or less, more preferably 10% by weight or less, and even more preferably 5% by weight or less in view of the stability of the aqueous dispersion and prevention of an excessive increase in the viscosity of the aqueous dispersion. When a polyfunctional monomer is used as the copolymerizable monomer, the content of the copolymerizable monomer in all monomer units of the (meth)acryl-based polymer (A) is preferably 5% by weight or less, more preferably 3% by weight or less, and even more preferably 1% by weight or less in view of the stability of the aqueous dispersion.

The methacryl-based copolymer (B) may be of any type as long as it contains an alkyl methacrylate and a carboxyl group-containing monomer as monomer units, contains 68 to 82% by weight of the monomer unit of the alkyl methacrylate based on all monomer units of the methacryl-based copolymer (B), and has a glass transition temperature of 0° C. to 180° C.

In view of emulsion polymerization reactivity, the alkyl methacrylate used to form the methacryl-based copolymer (B) preferably has a water solubility in a specific range, and an alkyl methacrylate having an alkyl group of 1 to 18 carbon atoms shown above for the (meth)acryl-based copolymer (A) is preferably used, so that the glass transition temperature can be easily controlled. Such alkyl methacrylates may be used singly or in combination of two or more. Specific examples of the alkyl methacrylate include those listed above. Methyl methacrylate, ethyl methacrylate, tert-butyl methacrylate, isobornyl methacrylate, cyclohexyl methacrylate and the like are preferred among those listed above. The methacryl-based copolymer (B) preferably contains 68 to 82% by weight, more preferably 70 to 80% by weight of the monomer unit of the alkyl methacrylate based on all monomer units of the methacryl-based copolymer (B). When the content of the monomer unit of the alkyl methacrylate is 82% by weight or less based on the total weight of all monomer units of the methacryl-based copolymer (B), depolarization can be made less likely to occur, and when the content of the monomer unit of the alkyl methacrylate is 68% by weight or more based on the total weight of all monomer units of the methacryl-based copolymer (B), reworkability can be improved.

Any of alkyl acrylates having an alkyl group of 1 to 18 carbon atoms shown above for the (meth)acryl-based copolymer (A) may also be used in addition to the alkyl methacrylate. Such alkyl acrylates may be used singly or in combination of two or more. Specific examples of the alkyl acrylate include those listed above. Alkyl acrylates having an alkyl group of 3 to 9 carbon atoms such as propyl acrylate, n-butyl acrylate, 2-ethylhexyl acrylate, and n-octyl acrylate are preferred among those listed above. The content of the monomer unit of the alkyl acrylate is preferably 30% by weight or less based on the total weight of all the monomer units of the methacryl-based copolymer (B).

A carboxyl group-containing monomer is also used to form the methacryl-based copolymer (B). Examples of the carboxyl group-containing monomer include those listed above for the (meth)acryl-based copolymer (A). The methacryl-based copolymer (B) preferably contains 0.1 to 10% by weight, more preferably 0.5 to 7% by weight, further more preferably 1 to 5% by weight of the monomer unit of the carboxyl group-containing monomer based on the total weight of all the monomer units of the methacryl-based copolymer (B).

The methacryl-based copolymer (B) may further contain a monomer unit derived from any of copolymerizable monomers shown above for the (meth)acryl-based copolymer (A). Copolymerizable monomers include alkoxysilyl group-containing monomers, phosphate group-containing monomers, polyfunctional monomers, and other monomers. Any of these copolymerizable monomers may be used at the same content as that in the (meth)acryl-based copolymer (A).

The type of the monomer units and the component composition are not restricted as long as the (meth)acryl-based copolymer (A) and the methacryl-based copolymer (B) each contain monomer units of the alkyl (meth)acrylate and the carboxyl group-containing monomer as monomer units and satisfy the requirements for the glass transition temperature. The above monomers may be used in any desired combination. Preferably, the (meth)acryl-based copolymer (A) and the methacryl-based copolymer (B) are obtained by emulsion polymerization using a vinyl monomer capable of forming a homopolymer with a glass transition temperature of 50° C. or higher. Examples of such a vinyl monomer capable of forming a homopolymer with a glass transition temperature of 50° C. or higher include acrylic acid (106° C.), methyl methacrylate (105° C.), tert-butyl methacrylate (107° C.), isobornyl acrylate (94° C.), and isobornyl methacrylate (180° C.).

The emulsion particle with the core-shell structure includes a core layer of the methacryl-based copolymer (B) and a shell layer of the (meth)acryl-based copolymer (A). According to the invention, the core-shell structure of the (meth)acryl-based copolymer (A) and the methacryl-based copolymer (B) prevents the adhesive strength from being high when a reworking process is performed at a high peel rate, in contrast to the prior art, and rather allows the adhesive strength to decrease as the peel rate increases, which makes it possible to achieve low adhesive strength at high peel rate and to easily perform reworking and recycling.

The emulsion particles with the core-shell structure each contain the (meth)acryl-based copolymer (A) and the methacryl-based copolymer (B) in a solid weight ratio (A)/(B) of 50/50 to 90/10. The ratio is based on 100% by weight of the total weight of the (meth)acryl-based copolymer (A) and the methacryl-based copolymer (B). When the (meth)acryl-based copolymer (A) and the methacryl-based copolymer (B) are present in a ratio within this range, the pressure-sensitive adhesive can have reliable adhesion and be prevented from having lower cohesive strength. In other words, the emulsion particle contains 50 to 90% by weight of the (meth)acryl-based copolymer (A) as the shell layer and 10 to 50% by weight of the methacryl-based copolymer (B) as the core layer based on 100% by weight of the total weight of the copolymers (A) and (B). The content of the (meth)acryl-based copolymer (A) is preferably 60% by weight or more, more preferably 70% by weight or more. If the content of the (meth)acryl-based copolymer (A) is less than 50% by weight, the pressure-sensitive adhesive will tend to have lower adhesion. On the other hand, the content of the (meth)acryl-based copolymer (A) is 90% by weight or less, preferably 85% by weight or less, more preferably less than 85% by weight. When the content of the (meth)acryl-based copolymer (A) is less than 85% by weight, the copolymer (A) can have a good effect without having any monomer unit other than the monomer units derived from the alkyl (meth)acrylate and the carboxyl group-containing monomer. If the content of the (meth)acryl-based copolymer (A) is more than 90% by weight, the pressure-sensitive adhesive can have lower cohesive strength and easily come off over time.

The emulsion particles with the core-shell structure can be obtained by a multi-stage emulsion polymerization process that includes forming the copolymer for the core layer by emulsion polymerization and then forming the copolymer for the shell layer by emulsion polymerization in the presence of the copolymer for the core layer. Specifically, each emulsion polymerization stage includes polymerizing, in water, a monomer component containing the alkyl (meth)acrylate for a monomer unit of the copolymer for the core or shell layer, in the presence of a surfactant (emulsifying agent) and a radial polymerization initiator to form the copolymer for the core or shell layer.

Emulsion polymerization of the monomer component may be performed by a conventional process. In the emulsion polymerization, for example, the monomer component may be appropriately mixed with a surfactant (emulsifying agent), a radical polymerization initiator, and an optional material such as a chain transfer agent. More specifically, each emulsion polymerization stage may be performed, for example, using a known emulsion polymerization method such as a batch mixing method (batch polymerization method), a monomer dropping method, or a monomer emulsion dropping method. In a monomer dropping method, continuous dropping or intermittent dropping is appropriately selected. These methods may be combined as needed. Reaction conditions and other conditions are appropriately selected, in which, for example, the polymerization temperature is preferably from about 40 to about 95° C., and the polymerization time is preferably from about 30 minutes to about 24 hours.

The surfactant (emulsifying agent) for use in the emulsion polymerization may be, but not limited to, any of various surfactants commonly used in emulsion polymerization. As the surfactant, an anionic or a nonionic surfactant is generally used. Examples of the anionic surfactant include higher fatty acid salts such as sodium oleate; alkylarylsulfonate salts such as sodium dodecylbenzenesulfonate; alkylsulfate ester salts such as sodium laurylsulfate and ammonium laurylsulfate; polyoxyethylene alkyl ether sulfate ester salts such as sodium polyoxyethylene lauryl ether sulfate; polyoxyethylene alkyl aryl ether sulfate ester salts such as sodium polyoxyethylene nonyl phenyl ether sulfate; alkyl sulfosuccinic acid ester salts such as sodium monooctyl sulfosuccinate, sodium dioctyl sulfosuccinate, and sodium polyoxyethylene lauryl sulfosuccinate, and derivatives thereof; and polyoxyethylene distyrenated phenyl ether sulfate ester salts. Examples of the nonionic surfactant include polyoxyethylene alkyl ethers such as polyoxyethylene lauryl ether and polyoxyethylene stearyl ether; polyoxyethylene alkyl phenyl ethers such as polyoxyethylene octyl phenyl ether and polyoxyethylene nonyl phenyl ether; sorbitan higher fatty acid esters such as sorbitan monolaurate, sorbitan monostearate, and sorbitan trioleate; polyoxyethylene sorbitan higher fatty acid esters such as polyoxyethylene sorbitan monolaurate; polyoxyethylene higher fatty acid esters such as polyoxyethylene monolaurate and polyoxyethylene monostearate; glycerin higher fatty acid esters such as oleic acid monoglyceride and stearic acid monoglyceride; and polyoxyethylene-polyoxypropylene block copolymers, and polyoxyethylene distyrenated phenyl ether.

Besides the above non-reactive surfactants, a reactive surfactant having a radical-polymerizable functional group containing an ethylenic unsaturated double bond may be used as the surfactant. The reactive surfactant may be a radical-polymerizable surfactant prepared by introducing a radical-polymerizable functional group (radically reactive group) such as a propenyl group or an allyl ether group into the anionic surfactant or the nonionic surfactant. These surfactants may be appropriately used alone or in any combination. Among these surfactants, the radical-polymerizable surfactant having a radical-polymerizable functional group is preferably used in view of the stability of the aqueous dispersion or the durability of the pressure-sensitive adhesive layer.

Examples of anionic reactive surfactants include alkyl ether surfactants (examples of commercially available products include AQUALON KH-05, KH-10, and KH-20 manufactured by Dai-ichi Kogyo Seiyaku Co., Ltd., ADEKA REASOAP SR-10N and SR-20N manufactured by ADEKA CORPORATION, LATEMUL PD-104 manufactured by Kao Corporation, and others); sulfosuccinic acid ester surfactants (examples of commercially available products include LATEMUL S-120, S-120A, S-180P, and S-180A manufactured by Kao Corporation and ELEMINOL JS-2 manufactured by Sanyo Chemical Industries, Ltd., and others); alkyl phenyl ether surfactants or alkyl phenyl ester surfactants (examples of commercially available products include AQUALON H-2855A, H-3855B, H-3855C, H-3856, HS-05, HS-10, HS-20, HS-30, BC-05, BC-10, and BC-20 manufactured by Dai-ichi Kogyo Seiyaku Co., Ltd., and ADEKA REASOAP SDX-222, SDX-223, SDX-232, SDX-233, SDX-259, SE-10N, and SE-20N manufactured by ADEKA CORPORATION); (meth)acrylate sulfate ester surfactants (examples of commercially available products include ANTOX MS-60 and MS-2N manufactured by Nippon Nyukazai Co., Ltd., ELEMINOL RS-30 manufactured by Sanyo Chemical Industries Co., Ltd., and others); and phosphoric acid ester surfactants (examples of commercially available products include H-3330PL manufactured by Dai-ichi Kogyo Seiyaku Co., Ltd., ADEKA REASOAP PP-70 manufactured by ADEKA CORPORATION, and others). Examples of nonionic reactive surfactants include alkyl ether surfactants (examples of commercially available products include ADEKA REASOAP ER-10, ER-20, ER-30, and ER-40 manufactured by ADEKA CORPORATION, LATEMUL PD-420, PD-430, and PD-450 manufactured by Kao Corporation, and others); alkyl phenyl ether surfactants or alkyl phenyl ester surfactants (examples of commercially available products include AQUALON RN-10, RN-20, RN-30, and RN-50 manufactured by Dai-ichi Kogyo Seiyaku Co., Ltd., ADEKA REASOAP NE-10, NE-20, NE-30, and NE-40 manufactured by ADEKA CORPORATION, and others); and (meth)acrylate sulfate ester surfactants (examples of commercially available products include RMA-564, RMA-568, and RMA-1114 manufactured by Nippon Nyukazai Co., Ltd., and others).

The surfactant is preferably added in an amount of 0.3 to 5 parts by weight, more preferably in an amount of 0.3 to 3 parts by weight, to 100 parts by weight of the monomer component used to form each of the (meth)acryl-based copolymer (A) and the methacryl-based copolymer (B). The addition of the surfactant in such an amount can improve adhesive properties and stability such as polymerization stability or mechanical stability.

The radical polymerization initiator may be, but not limited to, any known radical polymerization initiator commonly used in emulsion polymerization. Examples include azo initiators such as 2,2′-azobisisobutylonitrile, 2,2′-azobis(2-methylpropionamidine)disulfate, 2,2′-azobis(2-methylpropionamidine)dihydrochloride, 2,2′-azobis(2-amidinopropane)dihydrochloride, and 2,2′-azobis[2-(2-imidazoline-2-yl)propane]dihydrochloride; persulfate initiators such as potassium persulfate and ammonium persulfate; peroxide initiators such as benzoyl peroxide, tert-butyl hydroperoxide, and hydrogen peroxide; substituted ethane initiators such as phenyl-substituted ethane; and carbonyl initiators such as aromatic carbonyl compounds. These polymerization initiators may be appropriately used alone or in any combination. If desired, the emulsion polymerization may be performed using a redox system initiator, in which a reducing agent is used in combination with the polymerization initiator. This makes it easy to accelerate the emulsion polymerization rate or to perform the emulsion polymerization at low temperature. Examples of such a reducing agent include reducing organic compounds such as ascorbic acid, erythorbic acid, tartaric acid, citric acid, glucose, and metal salts of formaldehyde sulfoxylate or the like; reducing inorganic compounds such as sodium thiosulfate, sodium sulfite, sodium bisulfite, and sodium metabisulfite; and ferrous chloride, Rongalite, and thiourea dioxide.

The content of the radical polymerization initiator is typically from about 0.02 to about 1 part by weight, preferably from 0.02 to 0.5 parts by weight, more preferably from 0.05 to 0.3 parts by weight, based on 100 parts by weight of the monomer components, while it is appropriately selected. If it is less than 0.02 parts by weight, the radical polymerization initiator may be less effective. If it is more than 1 part by weight, the (meth)acryl-based polymer (A) or the methacryl-based copolymer (B) in the aqueous dispersion (polymer emulsion) may have a reduced molecular weight, so that the aqueous dispersion pressure-sensitive adhesive may have reduced durability. In the case of a redox system initiator, the reducing agent is preferably used in an amount of 0.01 to 1 part by weight based on 100 parts by weight of the total amount of the monomer components.

The chain transfer agent is used to control the molecular weight of the aqueous dispersion-type (meth)acryl-based polymer. Any chain transfer agent commonly used in emulsion polymerization may be used as needed. Examples include 1-dodecanthiol, mercaptoacetic acid, 2-mercaptoethanol, 2-ethylhexyl thioglycolate, 2,3-dimercapto-1-propanol, mercaptopropionic acid esters, and other mercaptans. These chain transfer agents may be appropriately used alone or in any combination. For example, the content of the chain transfer agent is 0.3 parts by weight or less, preferably from 0.001 to 0.3 parts by weight, based on 100 parts by weight of the monomer components.

The (meth)acryl-based polymer (A) or the methacryl-based copolymer (B) preferably has a weight average molecular weight of 1,000,000 or more. In particular, the weight average molecular weight is more preferably from 1,000,000 to 4,000,000. The pressure-sensitive adhesive obtained by the emulsion polymerization is preferred because the polymerization mechanism can produce very high molecular weight. It should be noted, however, that the pressure-sensitive adhesive obtained by the emulsion polymerization generally has a high gel content and cannot be subjected to GPC (gel permeation chromatography) measurement, which means that it is often difficult to identify the molecular weight by actual measurement.

The aqueous dispersion-type pressure-sensitive adhesive composition contains, as a main component, the emulsion particles with the core-shell structure. In the process of preparing the emulsion particles with the core-shell structure, an emulsion of the (meth)acryl-based copolymer (A) and an emulsion of the methacryl-based copolymer (B), which are not involved in forming the core-shell structure, can be produced. Therefore, the aqueous dispersion-type pressure-sensitive adhesive composition may also contain an emulsion of the (meth)acryl-based copolymer (A) and an emulsion of the methacryl-based copolymer (B) in addition to the emulsion particles with the core-shell structure.

The aqueous dispersion-type pressure-sensitive adhesive composition may also contain an additional component other than the emulsion particles with the core-shell structure, emulsion particles of the (meth)acryl-based copolymer (A), and emulsion particles of the methacryl-based copolymer (B). Such an additional component is preferably used at a content of 10% by weight or less.

If necessary, the composition may contain a crosslinking agent as the additional component in addition to the aqueous dispersion of the (meth)acryl-based copolymer (A) and the aqueous dispersion of the methacryl-based copolymer (B). The crosslinking agent to be used may be an isocyanate crosslinking agent, an epoxy crosslinking agent, an oxazoline crosslinking agent, an aziridine crosslinking agent, a carbodiimide crosslinking agent, a metal chelate crosslinking agent, or any other crosslinking agent commonly used in the art. When a functional group-containing monomer is used, these crosslinking agents have the effect of reacting with the functional group incorporated in the (meth)acryl-based polymer to form crosslinkage.

The content of the crosslinking agent (on solid basis) is generally, but not limited to, about 10 parts by weight or less based on 100 parts by weight of the total solids in the aqueous dispersion of the (meth)acryl-based copolymer (A) and the aqueous dispersion of the methacryl-based copolymer (B). Although the crosslinking agent can provide a cohesive strength for the pressure-sensitive adhesive layer, the use of the crosslinking agent tends to degrade adhesion. In the present invention, therefore, the crosslinking agent is not particularly necessary.

If necessary, the aqueous dispersion-type pressure-sensitive adhesive composition of the present invention may further appropriately contain any of various additives such as viscosity adjusting agent, releasing adjusting agent, tackifiers, plasticizers, softener, fillers including glass fibers, glass beads, metal power, or any other inorganic powder, pigments, colorants (pigments, dyes or the likes), pH adjusting agent (acid or base), antioxidants, and ultraviolet ray absorbing agents, silane coupling agents, without departing from the objects of the present invention. The aqueous dispersion-type pressure-sensitive adhesive composition may also contain fine particles to form a light-diffusing pressure-sensitive adhesive layer. These additives may also be added in the form of emulsion.

In the aqueous dispersion-type pressure-sensitive adhesive composition, the emulsion particles have a number average particle size of 10 to 100 nm, preferably 10 to 90 nm, more preferably 10 to 85 nm, even more preferably 10 to 80 nm. Within these ranges, depolarization can be reduced.

The pressure-sensitive adhesive layer of the invention is composed of emulsion particles and an interfacial part (including components used to stabilize the emulsion particles, such as a surfactant and a water-soluble component) between the emulsion particles. In the pressure-sensitive adhesive layer, light can be scattered from the emulsion particles. The main cause of the light scattering is the difference between the refractive index of the emulsion particles themselves and the refractive index of the interfacial part between the emulsion particles. Therefore, if the ratio of the interfacial part between the particles is high, depolarization can occur due to the light scattering at the interfacial part. Therefore, the smaller the interfacial part between the emulsion particles, the better. However, if the interfacial part is too small, the emulsion particles can be unstable so that they can form very large aggregated particles, which will tend to make the pressure-sensitive adhesive layer distorted or significantly degrade the appearance of the pressure-sensitive adhesive layer, because the interfacial part between the particles is made of emulsion particle-stabilizing components such as a surfactant and a water-soluble component. In the invention, the number average particle size of the emulsion particles in the aqueous dispersion-type pressure-sensitive adhesive composition is adjusted in the range of 10 to 100 nm, which makes it possible to minimize the light scattering mentioned above and to reduce depolarization. In other words, if the number average particle size exceeds 100 nm, the number of emulsion particles in the pressure-sensitive adhesive layer can be relatively small so that the amount of the surfactant (as a component of the interfacial part between the particles) per emulsion particle can be relatively large and the ratio of the interfacial part between the particles can be relatively high, which will tend to easily cause light scattering. If the number average particle size exceeds 100 nm, the pressure-sensitive adhesive layer can have a relatively large space that cannot be filled with emulsion particles, and the surfactant molecules as a component of the interfacial part between the particles can gather to make up a certain part of the particle interface in that space. In this case, the space with a refractive index different from that of the particles themselves becomes larger, which will tend to easily cause light scattering and depolarization. On the other hand, if the number average particle size is less than 10 nm, the particles can easily become unstable, so that they can be less likely to exist as primary particles and more likely to exist as secondary or aggregated particles, which can lead to the formation of coarse particles, an undesirable result.

The pressure-sensitive adhesive layer of the invention for an optical film is made from the aqueous dispersion-type pressure-sensitive adhesive composition described above. The pressure-sensitive adhesive layer can be formed by a process including applying the aqueous dispersion-type pressure-sensitive adhesive composition to a support substrate (an optical film or a release film) and then drying the composition.

Various methods may be used in the applying step of the aqueous dispersion-type pressure-sensitive adhesive composition. Examples include roll coating, kiss roll coating, gravure coating, reverse coating, roll brush coating, spray coating, dip roll coating, bar coating, knife coating, air knife coating, curtain coating, lip coating, and extrusion coating using a die coater or the like.

In the applying step, the amount of the application should be controlled so that a pressure-sensitive adhesive layer with a predetermined thickness (post-drying thickness) can be formed. The thickness (post-drying thickness) of the pressure-sensitive adhesive layer is generally set within the range of about 1 μm to about 100 μm, preferably within the range of 5 μm to 50 μm, and more preferably within the range of 10 μm to 40 μm.

In the process of forming the pressure-sensitive adhesive layer, the applied aqueous dispersion-type pressure-sensitive adhesive composition is then subjected to drying. The drying temperature is preferably 100° C. or more, more preferably 110° C. or more higher than the glass transition temperature (FOX theoretical value) of the pressure-sensitive adhesive composition. The upper limit to the drying temperature is preferably, but not limited to, less than a temperature that is 170° C. higher than the glass transition temperature. When the drying temperature falls within this range, the residual water content of the pressure-sensitive adhesive layer can be reduced, and the rate of the water-induced change in the refractive index of the interfacial part between the particles can also be reduced, so that depolarization can be reduced, which is advantageous. If the drying temperature is less than a temperature that is 100° C. higher than the glass transition temperature, the pressure-sensitive adhesive layer for an optical film can have a higher water content, so that the water can cause a large difference between the refractive indices of the particles and the interfacial part between the particles and also can cause the ratio of the interfacial part to be high, which can increase light scattering and thus cause depolarization. Such a result is not preferred. The drying time may be from about 0.5 to about 30 minutes, preferably from 1 to 10 minutes.

The resulting pressure-sensitive adhesive layer for an optical film preferably has a water content of 1.0% by weight or less based on the total weight of the pressure-sensitive adhesive layer. The pressure-sensitive adhesive layer for an optical film preferably has a water content as low as possible, and the content is more preferably 0% by weight. Unfortunately, it is difficult to remove water completely, and the pressure-sensitive adhesive layer usually has a residual water content of about 0.1% by weight.

The resulting pressure-sensitive adhesive layer for an optical film preferably provides a depolarization value of 0.015 or less, more preferably 0.012 or less, even more preferably 0.010 or less, which is calculated from the formula below. The lower limit to the depolarization value is not specified. The depolarization value is preferably as small as possible and ideally 0. If the depolarization value is more than 0.015, the pressure-sensitive adhesive layer attached to an optical film may tend to reduce the contrast of the optical film, which is not preferred.

Depolarization value=(the degree of polarization of the pressure-sensitive adhesive layer-bearing optical film)−(the degree of polarization of the optical film)

The degree of polarization of the pressure-sensitive adhesive layer-bearing optical film and the degree of polarization of the optical film can be measured by the method described in the section titled “EXAMPLES” in the specification.

The pressure-sensitive adhesive layer of the invention for an optical film can have an adhesive strength of 1 to 15 N/25 mm to glass at a peel rate of 300 mm/minute after the pressure-sensitive adhesive layer is bonded to the glass and stored at 23° C. for 30 days or less. The pressure-sensitive adhesive layer with an adhesive strength of 1 to 15 N/25 mm is advantageous in that it can have high durability while maintaining the adhesive strength to glass. The adhesive strength is preferably from 2 to 10 N/25 mm, more preferably from 4 to 10 N/25 mm. The adhesive strength to glass is determined taking the reworkability into account.

The pressure-sensitive adhesive layer of the present invention for an optical film can have an adhesive strength of 1 to 25 N/25 mm to glass at a peeling rate of 300 mm/minute after the pressure-sensitive adhesive layer is bonded to glass and stored at a temperature of 60° C. for a time period of 1,000 hours. The pressure-sensitive adhesive layer with an adhesive strength of 1 to 25 N/25 mm is preferred to maintain the adhesive strength to glass and to provide a sufficient level of durability. The adhesive strength is preferably from 1 to 24 N/25 mm. Specifically, the pressure-sensitive adhesive layer with an adhesive strength exceeding 10 N/25 mm can be evaluated to be the best. The pressure-sensitive adhesive layer should have such a level of adhesive strength in view of recyclability.

When stored under different conditions for the reworkability or the recyclability, the pressure-sensitive adhesive layer of the present invention for an optical film can have an adhesive strength to glass at a peeling rate exceeding 300 mm/minute which is equal to or less than the above specified value at a peeling rate of 300 mm/minute. Conventional pressure-sensitive adhesive layers cannot undergo a reworking process and recycling process at a high peeling rate because they increase in adhesive strength with increasing peeling rate. In contrast, the pressure-sensitive adhesive layer of the present invention for an optical film can undergo a reworking or recycling process at a high peeling rate because it can decrease in adhesive strength with increasing peeling rate when the peeling rate exceeds 300 mm/minute.

As described above, the pressure-sensitive adhesive layer of the present invention for an optical film has good reworkability or recyclability at high peeling rate. Thus, after bonded to a glass substrate, the pressure-sensitive adhesive layer-bearing optical film described below having the pressure-sensitive adhesive layer of the present invention can be removed from the glass substrate at a high peeling rate for reworking. The pressure-sensitive adhesive layer can be removed generally at a peeling rate of more than 300 mm/minute, preferably at a peeling rate of 500 mm/minute or more. As described above, the pressure-sensitive adhesive layer can have a low adhesive strength at such peeling rates, so that a reworking process can be successfully performed. There is no particular upper limit to the peeling rate. In general, a peeling rate of 30 m/minute or less is used.

Examples of the material used to form the release film include a plastic film such as a polyethylene, polypropylene, polyethylene terephthalate, or polyester film, a porous material such as paper, fabric, or nonwoven fabric, and an appropriate thin material such as a net, a foamed sheet, a metal foil, and a laminate thereof. A plastic film is preferably used, because of its good surface smoothness.

Any plastic film capable of protecting the pressure-sensitive adhesive layer may be used, examples of which include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the release film is generally from about 5 to about 200 μm, preferably from about 5 to about 100 μm. If necessary, the release film may be subjected to a release treatment and an antifouling treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the release film is appropriately subjected to a release treatment such as a silicone treatment, a long-chain alkyl treatment, or a fluorine treatment, the releasability from the pressure-sensitive adhesive layer can be further increased.

The pressure-sensitive adhesive layer may be exposed. In such a case, the pressure-sensitive adhesive layer may be protected by the release film until it is actually used. The release film may be used as is as a separator for a pressure-sensitive adhesive layer-bearing optical film, so that the process can be simplified.

The pressure-sensitive adhesive layer-bearing optical film of the invention includes an optical film and the pressure-sensitive adhesive layer or layers placed on one or both sides of the optical film. The pressure-sensitive adhesive layer-bearing optical film of the invention can be formed by the above process, which includes applying the aqueous dispersion-type pressure-sensitive adhesive composition to an optical film or a release film and drying the composition. The pressure-sensitive adhesive layer formed on a release film is bonded and transferred onto an optical film.

An optical film may also be coated with an anchor layer or subjected to any adhesion-facilitating treatment such as a corona treatment or a plasma treatment so as to have improved adhesion to a pressure-sensitive adhesive layer, and then the pressure-sensitive adhesive layer may be formed. The surface of the pressure-sensitive adhesive layer may also be subjected to an adhesion-facilitating treatment.

Materials that may be used to form the anchor layer preferably include an anchoring agent selected from polyurethane, polyester, polymers containing an amino group in the molecule, and polymers containing an oxazolinyl group in the molecule, in particular, preferably polymers containing an amino group in the molecule and polymers containing an oxazolinyl group in the molecule. Polymers containing an amino group in the molecule and polymers containing an oxazolinyl group in the molecule allow the amino group in the molecule or an oxazolinyl group in the molecule to react with a carboxyl group or the like in the pressure-sensitive adhesive or to make an interaction such as an ionic interaction, so that good adhesion can be ensured.

Examples of polymers containing an amino group in the molecule include polyethyleneimine, polyallylamine, polyvinylamine, polyvinylpyridine, polyvinylpyrrolidine, and a polymer of an amino group-containing monomer such as dimethylaminoethyl acrylate.

The optical film is, but not limited to the kinds, used for forming image display device such as liquid crystal display. A polarizing plate is exemplified. A polarizing plate including a polarizer and a transparent protective film provided on one side or both sides of the polarizer is generally used.

A polarizer is, but not limited to, various kinds of polarizer may be used. As a polarizer, for example, a film that is uniaxially stretched after having dichromatic substances, such as iodine and dichromatic dye, absorbed to hydrophilic polymer films, such as polyvinyl alcohol-based film, partially formalized polyvinyl alcohol-based film, and ethylene-vinyl acetate copolymer-based partially saponified film; polyene-based alignment films, such as dehydrated polyvinyl alcohol and dehydrochlorinated polyvinyl chloride, etc. may be mentioned. In these, a polyvinyl alcohol-based film on which dichromatic materials such as iodine, is absorbed and aligned after stretched is suitably used. Thickness of polarizer is, but not limited to, generally from about 4 μm to about 80 μm.

A polarizer that is uniaxially stretched after a polyvinyl alcohol-based film dyed with iodine is obtained by stretching a polyvinyl alcohol film by 3 to 7 times the original length, after dipped and dyed in aqueous solution of iodine. If needed the film may also be dipped in aqueous solutions containing boric acid and potassium iodide, which may include zinc sulfate, zinc chloride. Furthermore, before dyeing, the polyvinyl alcohol-based film may be dipped in water and rinsed if needed. By rinsing polyvinyl alcohol-based film with water, effect of preventing un-uniformity, such as unevenness of dyeing, is expected by making polyvinyl alcohol-based film swelled in addition that also soils and blocking inhibitors on the polyvinyl alcohol-based film surface may be washed off. Stretching may be applied after dyed with iodine or may be applied concurrently, or conversely dyeing with iodine may be applied after stretching. Stretching is applicable in aqueous solutions containing boric acid and potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

An optical film may be exemplified as other optical layers, such as a reflective plate, a transflective plate, a retardation plate (a half wavelength plate and a quarter wavelength plate included), a viewing angle compensation film, a brightness enhancement film, a surface treatment film or the like, which may be used for formation of a liquid crystal display etc. These are used in practice as an optical film, or as one layer or two layers or more of optical layers laminated with polarizing plate.

The surface treatment film may also be provided on and bonded to a front face plate. Examples of the surface treatment film include a hard-coat film for use in imparting scratch resistance to the surface, an antiglare treatment film for preventing glare on image display devices, and an anti-reflection film such as an anti-reflective film or a low-reflective film, etc. The front face plate is provided on and bonded to the surface of an image display device such as a liquid crystal display device, an organic EL display device, a CRT, or a PDP to protect the image display device or to provide a high-grade appearance or a differentiated design. The front face plate is also used as a support for a λ/4 plate in a 3D-TV. In a liquid crystal display device, for example, the front face plate is provided above a polarizing plate on the viewer side. When the pressure-sensitive adhesive layer according to the present invention is used, the same effect can be produced using a plastic base material such as a polycarbonate or poly (methyl methacrylate) base material for the front face plate, as well as using a glass base material.

Although an optical film with the above described optical layer laminated to the polarizing plate may be formed by a method in which laminating is separately carried out sequentially in manufacturing process of a liquid crystal display device or the like, an optical film in a form of being laminated beforehand has an outstanding advantage that it has excellent stability in quality and assembly workability, and thus manufacturing processes ability of a liquid crystal display device or the like may be raised. Proper adhesion means, such as a pressure-sensitive adhesive layer, may be used for laminating. On the occasion of adhesion of the above described polarizing plate and other optical films, the optical axis may be set as a suitable configuration angle according to the target retardation characteristics or the like.

The pressure-sensitive adhesive layer-bearing optical film of the present invention is preferably used to form various types of image display devices such as liquid crystal display devices. Liquid crystal display devices may be produced according to conventional techniques. Specifically, liquid crystal display devices are generally produced by appropriately assembling a liquid crystal cell or the likes and the pressure-sensitive adhesive layer-bearing optical film and optionally other components such as a lighting system and incorporating a driving circuit according to any conventional technique, except that the pressure-sensitive adhesive layer-bearing optical film of the present invention is used. Any type of liquid crystal cell may also be used such as a TN type, an STN type, a n type, a VA type and an IPS type.

Suitable liquid crystal display devices, such as liquid crystal display device with which the above pressure-sensitive adhesive layer-bearing optical film has been provided on one side or both sides of the display panel such as a liquid crystal cell, and with which a backlight or a reflective plate is used for a lighting system may be manufactured. In this case, the pressure-sensitive adhesive layer-bearing optical film of the present invention may be provided on one side or both sides of the display panel such as a liquid crystal cell. When providing the pressure-sensitive adhesive layer-bearing optical films on both sides, they may be of the same type or of different type. Furthermore, in assembling a liquid crystal display device, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display device: OLED) will be explained. Generally, in organic EL display device, a transparent electrode, an organic luminescence layer and a metal electrode are laminated on a transparent substrate in an order configuring an illuminant (organic electro luminescence illuminant). Here, a organic luminescence layer is a laminated material of various organic thin films, and much compositions with various combination are known, for example, a laminated material of hole injection layer including triphenylamine derivatives etc., a luminescence layer including fluorescent organic solids, such as anthracene; a laminated material of electronic injection layer including such a luminescence layer and perylene derivatives, etc.; laminated material of these hole injection layers, luminescence layer, and electronic injection layer etc.

An organic EL display device emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in an intermediate process is the same as a mechanism in common diodes, and, as is expected, there is a strong non-linear relationship between electric current and luminescence strength accompanied by rectification nature to applied voltage.

In an organic EL display device, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display device of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display device looks like mirror if viewed from outside.

In an organic EL display device containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarization plate, while preparing the polarization plate on the surface side of the transparent electrode.

Since the retardation plate and the polarization plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarization plate and the retardation plate is adjusted to π/4, the mirror surface of the metal electrode may be completely covered.

This means that only linearly polarized light component of the external light that enters as incident light into this organic EL display device is transmitted with the work of polarization plate. This linearly polarized light generally gives an elliptically polarized light by the retardation plate, and especially the retardation plate is a quarter wavelength plate, and moreover when the angle between the two polarization directions of the polarization plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarization plate, it cannot be transmitted through the polarization plate. As the result, mirror surface of the metal electrode may be completely covered.

### EXAMPLES

Hereinafter, the present invention is more specifically described with reference to the examples, which however are not intended to limit the present invention. In each example, “parts” and “%” are all by weight.

### Example 1

### Preparation of Monomer Emulsion (a1)

To a vessel were added 949.5 parts of butyl acrylate, 50 parts of acrylic acid, and 0.5 parts of 3-methacryloxypropyltrimethoxysilane (KBM-503 manufactured by Shin-Etsu Chemical Co., Ltd.) as raw materials and mixed to form a monomer mixture. Eight parts of a reactive surfactant (anionic) (AQUALON HS-10 manufactured by Dai-ichi Kogyo Seiyaku Co., Ltd.) and 381 parts of ion-exchanged water were then added to 600 parts of the monomer mixture prepared with the above composition. The mixture was stirred at 6,000 rpm for 5 minutes with a homo mixer (manufactured by PRIMIX Corporation) to prepare a monomer emulsion (a1).

### Preparation of Monomer Emulsion (b1)

To a vessel were added 700 parts of methyl methacrylate, 280 parts of butyl acrylate, and 20 parts of acrylic acid as raw materials and mixed to form a monomer mixture. Twenty-two parts of a reactive surfactant (anionic) (AQUALON HS-10 manufactured by Dai-ichi Kogyo Seiyaku Co., Ltd.) and 127 parts of ion-exchanged water were added to 200 parts of the monomer mixture prepared with the above composition. The mixture was stirred at 6,000 rpm for 5 minutes with a homo mixer (manufactured by PRIMIX Corporation) to prepare a monomer emulsion (b1).

(Preparation of Aqueous Dispersion-Type Pressure-Sensitive Adhesive Composition)

A reaction vessel equipped with a condenser tube, a nitrogen introducing tube, a thermometer, a dropping funnel, and a stirring blade was charged with 200 parts of the prepared monomer emulsion (b1) and 330 parts of ion-exchanged water. Subsequently, after the air in the reaction vessel was sufficiently replaced with nitrogen gas, 0.6 parts of ammonium persulfate was added to the reaction vessel. The mixture was subjected to polymerization at 60° C. for 1 hour with stirring, so that a copolymer for forming a core layer was obtained. Subsequently, 800 parts of the monomer emulsion (a1) was added dropwise over 3 hours to the reaction vessel being kept at 60° C. The mixture was then subjected to polymerization for 3 hours to form a shell layer, so that an aqueous dispersion having a solid concentration of 46.0% and containing polymer emulsion particles with a core-shell structure was obtained. Subsequently, after the aqueous dispersion containing the polymer emulsion particles was cooled to room temperature, 10% ammonia water was added thereto to adjust pH to 8, so that an aqueous dispersion-type pressure-sensitive adhesive composition having an adjusted solid content of 45.2% and containing emulsion particles with a core-shell structure was obtained. The resulting polymer emulsion particles had a number average particle size of 80 nm.

(Formation of Pressure-Sensitive Adhesive Layer and Production of Pressure-Sensitive Adhesive Layer-Bearing Polarizing Plate)

Using a die coater, the aqueous dispersion-type pressure-sensitive adhesive composition was applied to a release-treated polyethylene terephthalate film (38 μm in thickness) so that a 20-μm-thick coating could be formed after drying. The composition was then dried at 120° C. for 5 minutes to form a pressure-sensitive adhesive layer. The pressure-sensitive adhesive layer was bonded to a polarizing plate (SEG-DU (product name) manufactured by Nitto Denko Corporation) to produce a pressure-sensitive adhesive layer-bearing polarizing plate.

### Example 2

### Preparation of Monomer Emulsion (b2)

A monomer emulsion (b2) was prepared using the same process as in the preparation of the monomer emulsion (b1) in Example 1, except that a monomer mixture of 800 parts of methyl methacrylate, 180 parts of butyl acrylate, and 20 parts of acrylic acid was used instead as the raw material and the amount of AQUALON HS-10 was changed to 42 parts.

(Preparation of Aqueous Dispersion-Type Pressure-Sensitive Adhesive Composition, Formation of Pressure-Sensitive Adhesive Layer, and Production of Pressure-Sensitive Adhesive Layer-Bearing Polarizing Plate)

An aqueous dispersion-type pressure-sensitive adhesive composition (84 nm in the number average particle size of polymer emulsion particles) was prepared, a pressure-sensitive adhesive layer was formed, and a pressure-sensitive adhesive layer-bearing polarizing plate was produced as in Example 1, except that the monomer emulsion (b2) was used instead of the monomer emulsion (b1) in the preparation of the aqueous dispersion-type pressure-sensitive adhesive composition.

### Example 3

### Preparation of Monomer Emulsion (b3)

A monomer emulsion (b3) was prepared using the same process as in the preparation of the monomer emulsion (b1) in Example 1, except that a monomer mixture of 700 parts of tert-butyl methacrylate, 280 parts of butyl acrylate, and 20 parts of acrylic acid was used instead as the raw material.

(Preparation of Aqueous Dispersion-Type Pressure-Sensitive Adhesive Composition, Formation of Pressure-Sensitive Adhesive Layer, and Production of Pressure-Sensitive Adhesive Layer-Bearing Polarizing Plate)

An aqueous dispersion-type pressure-sensitive adhesive composition (90 nm in the number average particle size of polymer emulsion particles) was prepared, a pressure-sensitive adhesive layer was formed, and a pressure-sensitive adhesive layer-bearing polarizing plate was produced as in Example 1, except that the monomer emulsion (b3) was used instead of the monomer emulsion (b1) in the preparation of the aqueous dispersion-type pressure-sensitive adhesive composition.

### Example 4

### Preparation of Monomer Emulsion (b4)

A monomer emulsion (b4) was prepared using the same process as in the preparation of the monomer emulsion (b3) in Example 3, except that a monomer mixture of 800 parts of tert-butyl methacrylate, 180 parts of butyl acrylate, and 20 parts of acrylic acid was used instead as the raw material.

(Preparation of Aqueous Dispersion-Type Pressure-Sensitive Adhesive Composition, Formation of Pressure-Sensitive Adhesive Layer, and Production of Pressure-Sensitive Adhesive Layer-Bearing Polarizing Plate)

An aqueous dispersion-type pressure-sensitive adhesive composition (85 nm in the number average particle size of polymer emulsion particles) was prepared, a pressure-sensitive adhesive layer was formed, and a pressure-sensitive adhesive layer-bearing polarizing plate was produced as in Example 3, except that the monomer emulsion (b4) was used instead of the monomer emulsion (b3) in the preparation of the aqueous dispersion-type pressure-sensitive adhesive composition.

### Comparative Example 1

### Preparation of Monomer Emulsion (b5)

A monomer emulsion (b5) was prepared using the same process as in the preparation of the monomer emulsion (b1) in Example 1, except that a monomer mixture of 800 parts of methyl methacrylate, 180 parts of butyl acrylate, and 20 parts of acrylic acid was used instead as the raw material.

(Preparation of Aqueous Dispersion-Type Pressure-Sensitive Adhesive Composition, Formation of Pressure-Sensitive Adhesive Layer, and Production of Pressure-Sensitive Adhesive Layer-Bearing Polarizing Plate)

An aqueous dispersion-type pressure-sensitive adhesive composition (120 nm in the number average particle size of polymer emulsion particles) was prepared, a pressure-sensitive adhesive layer was formed, and a pressure-sensitive adhesive layer-bearing polarizing plate was produced as in Example 1, except that the monomer emulsion (b5) was used instead of the monomer emulsion (b1) in the preparation of the aqueous dispersion-type pressure-sensitive adhesive composition.

### Comparative Example 2

### Preparation of Monomer Emulsion (b6)

A monomer emulsion (b6) was prepared using the same process as in the preparation of the monomer emulsion (b1) in Example 1, except that a monomer mixture of 900 parts of methyl methacrylate, 80 parts of butyl acrylate, and 20 parts of acrylic acid was used instead as the raw material.

(Preparation of Aqueous Dispersion-Type Pressure-Sensitive Adhesive Composition, Formation of Pressure-Sensitive Adhesive Layer, and Production of Pressure-Sensitive Adhesive Layer-Bearing Polarizing Plate)

An aqueous dispersion-type pressure-sensitive adhesive composition (110 nm in the number average particle size of polymer emulsion particles) was prepared, a pressure-sensitive adhesive layer was formed, and a pressure-sensitive adhesive layer-bearing polarizing plate was produced as in Example 1, except that the monomer emulsion (b6) was used instead of the monomer emulsion (b1) in the preparation of the aqueous dispersion-type pressure-sensitive adhesive composition.

### Comparative Example 3

### Preparation of Monomer Emulsion (a2)

To a vessel were added 750 parts of butyl acrylate, 200 parts of methyl methacrylate, and 50 parts of acrylic acid as raw materials and mixed to form a monomer mixture. Eight parts of a reactive surfactant (anionic) (AQUALON HS-10 manufactured by Dai-ichi Kogyo Seiyaku Co., Ltd.) and 381 parts of ion-exchanged water were then added to 600 parts of the monomer mixture prepared with the above composition. The mixture was stirred at 6,000 rpm for 5 minutes with a homo mixer (manufactured by PRIMIX Corporation) to prepare a monomer emulsion (a2).

### Preparation of Monomer Emulsion (b7)

To a vessel were added 949.5 parts of butyl acrylate, 50 parts of acrylic acid, and 0.5 parts of 3-methacryloyloxypropylatetrimethoxysilane (KBM-503 manufactured by Shin-Etsu Chemical Co., Ltd.) as raw materials and mixed to form a monomer mixture. Twenty-two parts of a reactive surfactant (anionic) (AQUALON HS-10 manufactured by Dai-ichi Kogyo Seiyaku Co., Ltd.) and 127 parts of ion-exchanged water were then added to 200 parts of the monomer mixture prepared with the above composition. The mixture was stirred at 6,000 rpm for 5 minutes with a homo mixer (manufactured by PRIMIX Corporation) to prepare a monomer emulsion (b7).

(Preparation of Aqueous Dispersion-Type Pressure-Sensitive Adhesive Composition, Formation of Pressure-Sensitive Adhesive Layer, and Production of Pressure-Sensitive Adhesive Layer-Bearing Polarizing Plate)

An aqueous dispersion-type pressure-sensitive adhesive composition (105 nm in the number average particle size of polymer emulsion particles) was prepared, a pressure-sensitive adhesive layer was formed, and a pressure-sensitive adhesive layer-bearing polarizing plate was produced as in Example 1, except that the monomer emulsions (a2) and (b7) were used instead of the monomer emulsions (a1) and (b1), respectively, in the preparation of the aqueous dispersion-type pressure-sensitive adhesive composition.

### Comparative Example 4

### Preparation of Monomer Emulsion (a3)

To a vessel were added 780 parts of butyl acrylate, 200 parts of methyl methacrylate, and 20 parts of acrylic acid as raw materials and mixed to form a monomer mixture. Eight parts of a reactive surfactant (anionic) (AQUALON HS-10 manufactured by Dai-ichi Kogyo Seiyaku Co., Ltd.) and 381 parts of ion-exchanged water were then added to 600 parts of the monomer mixture prepared with the above composition. The mixture was stirred at 6,000 rpm for 5 minutes with a homo mixer (manufactured by PRIMIX Corporation) to prepare a monomer emulsion (a3).

### Preparation of Monomer Emulsion (b8)

To a vessel were added 780 parts of butyl acrylate, 200 parts of methyl methacrylate, and 20 parts of acrylic acid as raw materials and mixed to form a monomer mixture. Twenty-two parts of a reactive surfactant (anionic) (AQUALON HS-10 manufactured by Dai-ichi Kogyo Seiyaku Co., Ltd.) and 127 parts of ion-exchanged water were then added to 200 parts of the monomer mixture prepared with the above composition. The mixture was stirred at 6,000 rpm for 5 minutes with a homo mixer (manufactured by PRIMIX Corporation) to prepare a monomer emulsion (b8).

(Preparation of Aqueous Dispersion-Type Pressure-Sensitive Adhesive Composition, Formation of Pressure-Sensitive Adhesive Layer, and Production of Pressure-Sensitive Adhesive Layer-Bearing Polarizing Plate)

An aqueous dispersion-type pressure-sensitive adhesive composition (60 nm in the number average particle size of polymer emulsion particles) was prepared, a pressure-sensitive adhesive layer was formed, and a pressure-sensitive adhesive layer-bearing polarizing plate was produced as in Example 1, except that the monomer emulsions (a3) and (b8) were used instead of the monomer emulsions (a1) and (b1), respectively, in the preparation of the aqueous dispersion-type pressure-sensitive adhesive composition.

### Comparative Example 5

### Preparation of Monomer Emulsion (a4)

To a vessel were added 950 parts of butyl acrylate and 50 parts of acrylic acid as raw materials and mixed to form a monomer mixture. Eight parts of a reactive surfactant (anionic) (AQUALONHS-10 manufactured by Dai-ichi Kogyo Seiyaku Co., Ltd.) and 381 parts of ion-exchanged water were then added to 600 parts of the monomer mixture prepared with the above composition. The mixture was stirred at 6,000 rpm for 5 minutes with a homo mixer (manufactured by PRIMIX Corporation) to prepare a monomer emulsion (a4).

### Preparation of Monomer Emulsion (b9)

To a vessel were added 950 parts of butyl acrylate and 50 parts of acrylic acid as raw materials and mixed to form a monomer mixture. Twenty-two parts of a reactive surfactant (anionic) (AQUALONHS-10 manufactured by Dai-ichi Kogyo Seiyaku Co., Ltd.) and 127 parts of ion-exchanged water were then added to 200 parts of the monomer mixture prepared with the above composition. The mixture was stirred at 6,000 rpm for 5 minutes with a homo mixer (manufactured by PRIMIX Corporation) to prepare a monomer emulsion (b9).

(Preparation of Aqueous Dispersion-Type Pressure-Sensitive Adhesive Composition, Formation of Pressure-Sensitive Adhesive Layer, and Production of Pressure-Sensitive Adhesive Layer-Bearing Polarizing Plate)

An aqueous dispersion-type pressure-sensitive adhesive composition (90 nm in the number average particle size of polymer emulsion particles) was prepared, a pressure-sensitive adhesive layer was formed, and a pressure-sensitive adhesive layer-bearing polarizing plate was produced as in Example 1, except that the monomer emulsions (a4) and (b9) were used instead of the monomer emulsions (a1) and (b1), respectively, in the preparation of the aqueous dispersion-type pressure-sensitive adhesive composition.

### Comparative Example 6

### Preparation of Monomer Emulsion (b10)

A monomer emulsion (b10) was prepared using the same process as in the preparation of the monomer emulsion (b1) in Example 1, except that a monomer mixture of 850 parts of methyl methacrylate, 130 parts of butyl acrylate, and 20 parts of acrylic acid was used instead as the raw material and the amount of AQUALON HS-10 was changed to 42 parts.

(Preparation of Aqueous Dispersion-Type Pressure-Sensitive Adhesive Composition, Formation of Pressure-Sensitive Adhesive Layer, and Production of Pressure-Sensitive Adhesive Layer-Bearing Polarizing Plate)

An aqueous dispersion-type pressure-sensitive adhesive composition (82 nm in the number average particle size of polymer emulsion particles) was prepared, a pressure-sensitive adhesive layer was formed, and a pressure-sensitive adhesive layer-bearing polarizing plate was produced as in Example 1, except that the monomer emulsion (b10) was used instead of the monomer emulsion (b1) in the preparation of the aqueous dispersion-type pressure-sensitive adhesive composition.

### Comparative Example 7

### Preparation of Monomer Emulsion (b11)

A monomer emulsion (b11) was prepared using the same process as in the preparation of the monomer emulsion (b1) in Example 1, except that a monomer mixture of 650 parts of methyl methacrylate, 330 parts of butyl acrylate, and 20 parts of acrylic acid was used instead as the raw material.

(Preparation of Aqueous Dispersion-Type Pressure-Sensitive Adhesive Composition, Formation of Pressure-Sensitive Adhesive Layer, and Production of Pressure-Sensitive Adhesive Layer-Bearing Polarizing Plate)

An aqueous dispersion-type pressure-sensitive adhesive composition (84 nm in the number average particle size of polymer emulsion particles) was prepared, a pressure-sensitive adhesive layer was formed, and a pressure-sensitive adhesive layer-bearing polarizing plate was produced as in Example 1, except that the monomer emulsion (b11) was used instead of the monomer emulsion (b1) in the preparation of the aqueous dispersion-type pressure-sensitive adhesive composition.

Table 1 shows the glass transition temperature (theoretical value based on the FOX equation) of the (meth)acryl-based copolymer emulsion obtained in each example. Table 1 also shows the type of the monomer emulsion used to form each copolymer emulsion and other products, the monomers in the monomer emulsion, and the content (% by weight) of the monomers in the monomer emulsion.

The pressure-sensitive adhesive layer-bearing polarizing plates obtained in the examples and the comparative examples were evaluated as described below. Tables 1 and 2 show the evaluation results.

<Number Average Particle Size>

The number average particle size of polymer emulsion particles was measured as follows. The prepared aqueous dispersion-type pressure-sensitive adhesive composition was diluted with distilled water to a solid content of about 1% by weight, and measured for the number average particle size with the analyzer shown below. Table 1 shows the results. Analyzer: Laser diffraction scattering particle size distribution analyzer (LS13 320 (PIDS mode) manufactured by Beckman Coulter, Inc.)

Refractive index of dispersoid: 1.48 (poly(n-butyl acrylate) was used)
Refractive index of dispersion medium: 1.333

<Depolarization>

The degree of polarization of the pressure-sensitive adhesive layer-bearing polarizing plate and the degree of polarization of the polarizing plate were measured with a spectrophotometer (V-7100 (product name) manufactured by JASCO Corporation). The transmission axis of the polarizing film was placed perpendicular to the plane of vibration of polarized light from a prism when the transmittance K₂ (minimum transmittance) was measured. The polarizing film was then rotated by 90° when the transmittance K₁ (maximum transmittance) was measured. The degree of polarization was calculated from the following formula:

$$Degree ( \% ) of polarization = \frac{{K}_{1} - {K}_{2}}{{K}_{1} + {K}_{2}} \times 100 \qquad [ Formula 2 ]$$

The depolarization value was calculated from the formula below using the degrees of polarization of the pressure-sensitive adhesive layer-bearing polarizing plate and the polarizing plate measured by the above method. Table 2 shows the results.

Depolarization value=(the degree of polarization of the pressure-sensitive adhesive layer-bearing polarizing plate)−(the degree of polarization of the polarizing plate)

<Reworkability>

The pressure-sensitive adhesive layer-bearing polarizing plate obtained in each of the examples and the comparative examples was cut into a piece of 25 mm wide and 150 mm long. The cut piece was bonded to a 0.7-mm-thick, non-alkali glass plate (Corning Eagle XG manufactured by Corning Incorporated) and stored in an autoclave at 50° C. and 0.5 MPa for 15 minutes. The cut piece was then allowed to stand in an environment at 23° C. and 50% R.H. for 2 weeks. Thereafter, adhesive strength (N/25 mm) of each of the cut pieces was measured when it was peeled off from the glass plate at a peeling angle of 180° and at each of different peeling rates (300 mm/minute, 1 m/minute, and 30 m/minute). A high-speed peeling tester (High-Low Temperature Peel Strength Tester manufactured by KOUKEN CO., LTD.) was used at a peeling rate of 20 m/minute or less, and another high-speed peeling tester (TE-702 manufactured by TESTER SANGYO CO,. LTD.) was used at a peeling rate of more than 20 m/minute. The adhesive strength was evaluated using five measurements. After the cut piece was peeled off, the level of adhesive residue on the non-alkali glass surface was visually rated on a scale of 1 to 5 as shown below. The results are shown in Table 2.

5: No adhesive residue is left on the glass surface.
4: Avery thin trace of adhesive residue is left on part of the glass surface.
3: Avery thin trace of adhesive residue is left over the glass surface.
2: Thin adhesive residues are left over the glass surface.
1: The pressure-sensitive adhesive layer is left over the glass surface, and cohesive failure occurs in the pressure-sensitive adhesive layer.

<Recyclability>

The pressure-sensitive adhesive layer-bearing polarizing plate obtained in each of the examples and the comparative examples was cut into a piece of 25 mm wide and 150 mm long. The cut piece was bonded to a 0.7-mm-thick, non-alkali glass plate (Corning Eagle XG manufactured by Corning Incorporated) and stored in an autoclave at 50° C. and 0.5 MPa for 15 minutes. The cut piece was further stored at 60° C. for 1,000 hours and then allowed to stand in an environment at 23° C. and 50% R.H. for 3 hours. Thereafter, adhesive strength (N/25 mm) of each of the cut pieces was measured when it was peeled off from the glass plate at a peeling angle of 180° and at each of different peeling rates (300 mm/minute, 1 m/minute, and 30 m/minute). A high-speed peeling tester (High-Low Temperature Peel Strength Tester manufactured by KOUKEN CO., LTD.) was used at a peeling rate of 20 m/minute or less, and another high-speed peeling tester (TE-702 manufactured by TESTER SANGYO CO,. LTD.) was used at a peeling rate of more than 20 m/minute. The adhesive strength was evaluated using five measurements. After the cut piece was peeled off, the level of adhesive residue on the non-alkali glass surface was visually rated on a scale of 1 to 5 as shown below. The results are shown in Table 2.

5: No adhesive residue is left on the glass surface.
4: A very thin trace of adhesive residue is left on part of the glass surface.
3: A very thin trace of adhesive residue is left over the glass surface.
2: Thin adhesive residues are left over the glass surface.
1: The pressure-sensitive adhesive layer is left over the glass surface, and cohesive failure occurs in the pressure-sensitive adhesive layer.

TABLE 1

| | (Meth)acryl-based copolymer (A) | | | Methacryl-based copolymer (B) | | | Tg | (A)/(B) | Particle |
|---|---|---|---|---|---|---|---|---|---|
| | | Weight ratio | Tg | | Weight ratio | Tg | difference | (weight | size |
| | Composition | (wt %) | (° C.) | Composition | (wt %) | (° C.) | (° C.) | ratio) | (nm) |
| Example 1 | BA/AA/KBM503 | 94.95/5/0.05 | −40 | MMA/BA/AA | 70/28/2 | 46 | 86 | 80/20 | 80 |
| Example 2 | BA/AA/KBM503 | 94.95/5/0.05 | −40 | MMA/BA/AA | 80/18/2 | 65 | 105 | 80/20 | 84 |
| Example 3 | BA/AA/KBM503 | 94.95/5/0.05 | −40 | t-BMA/BA/AA | 70/28/2 | 47 | 87 | 80/20 | 90 |
| Example 4 | BA/AA/KBM503 | 94.95/5/0.05 | −40 | t-BMA/BA/AA | 80/18/2 | 66 | 106 | 80/20 | 85 |
| Comparative | BA/AA/KBM503 | 94.95/5/0.05 | −40 | MMA/BA/AA | 80/18/2 | 65 | 105 | 80/20 | 120 |
| Example 1 | | | | | | | | | |
| Comparative | BA/AA/KBM503 | 94.95/5/0.05 | −40 | MMA/BA/AA | 90/8/2 | 86 | 126 | 80/20 | 110 |
| Example 2 | | | | | | | | | |
| Comparative | BA/MMA/AA | 75/20/5 | −20 | BA/AA/KBM503 | 94.95/5/0.05 | −40 | 20 | 80/20 | 105 |
| Example 3 | | | | | | | | | |
| Comparative | BA/MMA/AA | 78/20/2 | −23 | BA/MMA/AA | 78/20/2 | −23 | 0 | 80/20 | 60 |
| Example 4 | | | | | | | | | |
| Comparative | BA/AA | 95/5 | −40 | BA/AA | 95/5 | −40 | 0 | 80/20 | 90 |
| Example 5 | | | | | | | | | |
| Comparative | BA/AA/KBM503 | 94.95/5/0.05 | −40 | MMA/BA/AA | 85/13/2 | 76 | 116 | 80/20 | 82 |
| Example 6 | | | | | | | | | |
| Comparative | BA/AA/KBM503 | 94.95/5/0.05 | −40 | MMA/BA/AA | 65/33/2 | 38 | 78 | 80/20 | 84 |
| Example 7 | | | | | | | | | |

TABLE 2

| | Reworkability | | | | | | Recyclability | |
|---|---|---|---|---|---|---|---|---|
| | Peel rate | | | | | | | |
| | 300 mm/min | | 1 m/min | | 30 m/min | | 300 mm/min | |
| | Adhesive | | Adhesive | | Adhesive | | Adhesive | |
| | strength | Adhesive | strength | Adhesive | strength | Adhesive | strength | Adhesive |
| | (N/25 mm) | residue | (N/25 mm) | residue | (N/25 mm) | residue | (N/25 mm) | residue |
| Example 1 | 9.1 | 5 | 6.7 | 5 | 5.2 | 5 | 20.1 | 5 |
| Example 2 | 8.4 | 5 | 6.3 | 5 | 4.9 | 5 | 18.4 | 5 |
| Example 3 | 10.8 | 5 | 8.4 | 5 | 6.3 | 5 | 23.1 | 5 |
| Example 4 | 9.2 | 5 | 7.1 | 5 | 5.3 | 5 | 21.5 | 5 |
| Comparative | 9.1 | 5 | 7.3 | 5 | 5.5 | 5 | 18.7 | 5 |
| Example 1 | | | | | | | | |
| Comparative | 8.1 | 5 | 5.9 | 5 | 4.5 | 5 | 17.5 | 5 |
| Example 2 | | | | | | | | |
| Comparative | 2.4 | 5 | 3.3 | 5 | 6.4 | 4 | 18.9 | 2 |
| Example 3 | | | | | | | | |
| Comparative | 3.1 | 5 | 4.6 | 5 | 6.7 | 4 | 19.7 | 2 |
| Example 4 | | | | | | | | |
| Comparative | 7.6 | 5 | 9.9 | 4 | 19.4 | 2 | 22.5 | 1 |
| Example 5 | | | | | | | | |
| Comparative | 7.3 | 5 | 5.7 | 5 | 4.2 | 5 | 16.8 | 5 |
| Example 6 | | | | | | | | |
| Comparative | 10.2 | 5 | 8.4 | 5 | 6.2 | 5 | 20.8 | 1 |
| Example 7 | | | | | | | | |

| | Recyclability | | | | |
|---|---|---|---|---|---|
| | Peel rate | | | | |
| | 1 m/min | | 30 m/min | | |
| | Adhesive | | Adhesive | | |
| | strength | Adhesive | strength | Adhesive | |
| | (N/25 mm) | residue | (N/25 mm) | residue | Depolarization |
| Example 1 | 17.2 | 5 | 11.4 | 5 | 0.0125 |
| Example 2 | 15.7 | 5 | 10.3 | 5 | 0.0130 |
| Example 3 | 18.7 | 5 | 13.1 | 5 | 0.0110 |
| Example 4 | 14.5 | 5 | 12.5 | 5 | 0.0116 |
| Comparative | 16.4 | 5 | 11.7 | 5 | 0.0160 |
| Example 1 | | | | | |
| Comparative | 14.7 | 5 | 9.7 | 5 | 0.0166 |
| Example 2 | | | | | |
| Comparative | 29.4 | 1 | 34.9 | 1 | 0.0156 |
| Example 3 | | | | | |
| Comparative | 26.3 | 1 | 34.7 | 1 | 0.0130 |
| Example 4 | | | | | |
| Comparative | 25.8 | 1 | 33.6 | 1 | 0.0106 |
| Example 5 | | | | | |
| Comparative | 14.1 | 5 | 9.4 | 5 | 0.0164 |
| Example 6 | | | | | |
| Comparative | 28.2 | 1 | 36.1 | 1 | 0.0118 |
| Example 7 | | | | | |

Table 2 shows that the pressure-sensitive adhesive layer-bearing optical film (pressure-sensitive adhesive layer-bearing polarizing plate) of each of Examples has good reworkability and good recyclability and produces less depolarization. On the other hand, Comparative Examples 1, 2 and 6 produce more depolarization although they have good reworkability and good recyclability, whereas Comparative Examples 4 and 5 have poor reworkability or recyclability although they produce less depolarization. Comparative Example 7 has poor recyclability although it has good reworkability and produces less depolarization. Comparative Example 3 is not satisfactory in any of the reworkability, the recyclability, and the depolarization.

In the table, BA: butyl acrylate (228.15 K), AA: acrylic acid (379.15 K), KBM503: 3-methacryloyloxypropyl-trimethoxysilane (KBM-503 manufactured by Shin-Etsu Chemical Co., Ltd.), MMA: methyl methacrylate (378.15 K), and t-BMA: tert-butyl methacrylate (380.15 K). Each parenthesized temperature is the glass transition temperature (K) of a homopolymer of each monomer, which is used in the calculation of the glass transition temperature.

1. A pressure-sensitive adhesive layer for an optical film made from an aqueous dispersion-type pressure-sensitive adhesive composition, wherein
the aqueous dispersion-type pressure-sensitive adhesive composition contains an emulsion particle having a core-shell structure comprising a shell layer of (A) a (meth)acryl-based copolymer and a core layer of (B) a methacryl-based copolymer in a single emulsion particle,
the (meth)acryl-based copolymer (A) contains an alkyl (meth)acrylate and a carboxyl group-containing monomer as a monomer unit and has a glass transition temperature of −55° C. to less than 0° C., which is calculated based on monofunctional monomers for monomer units,
the methacryl-based copolymer (B) contains an alkyl methacrylate and a carboxyl group-containing monomer as a monomer unit, wherein a content of the monomer unit of the alkyl methacrylate is 68 to 82% by weight of all monomer units of the methacryl-based copolymer (B),
the methacryl-based copolymer (B) has a glass transition temperature of 0° C. to 180° C.,
a difference of the glass transition temperatures between the (meth)acryl-based copolymer (A) and the methacryl-based copolymer (B) is 50° C. or more,
a mixture ratio (A)/(B) (on a solid weight basis) of the (meth)acryl-based copolymer (A) and the methacryl-based copolymer (B) is in the range of 50/50 to 90/10,
the emulsion particle in the aqueous dispersion-type pressure-sensitive adhesive composition has a number average particle size of 10 nm to 100 nm.

2. The pressure-sensitive adhesive layer according to claim 1, which has an adhesive strength of 1 to 15 N/25 mm to glass at a peel rate of 300 mm/minute after bonded to the glass and stored at 23° C. for 30 days or less, and which has an adhesive strength, to glass at a peel rate of more than 300 mm/minute, of equal to less than the adhesive strength to glass at a peel rate of 300 mm/minute.

3. The pressure-sensitive adhesive layer according to claim 1, which has an adhesive strength of 1 to 25 N/25 mm to glass at a peel rate of 300 mm/minute after bonded to the glass and stored at 60° C. for 1,000 hours, and which has an adhesive strength, to glass at a peel rate of more than 300 mm/minute, of equal to less than the adhesive strength to glass at a peel rate of 300 mm/minute.

4. The pressure-sensitive adhesive layer according to claim 1, which provides a depolarization value of 0.015 or less, wherein the depolarization value is a difference between the degree of polarization of a pressure-sensitive adhesive layer-bearing optical film comprising an optical film and the pressure-sensitive adhesive layer placed thereon and the degree of polarization of the optical film itself.

5. The pressure-sensitive adhesive layer according to claim 1, wherein the (meth)acryl-based copolymer (A) and the methacryl-based copolymer (B) are each obtained by emulsion polymerization of a monomer mixture containing a vinyl monomer capable of forming a homopolymer with a glass transition temperature of 50° C. or higher.

6. A pressure-sensitive adhesive layer-bearing optical film, comprising an optical film and the pressure-sensitive adhesive layer according to claim 1 placed on at least one side of the optical film.

7. An image display device, comprising at least one piece of the pressure-sensitive adhesive layer-bearing optical film according to claim 6.
